(19) United States
(12) Patent Application Publication
(10) Pub. No.: US 2026/0205512 A1
(43) Pub. Date: Jul. 16, 2026

(54) PRIMARY NODE ELECTION WITH CLOUD INTENT FLEXIBILITY

(71) Applicant: Dell Products L.P., Round Rock, TX (US)

(72) Inventors: Xueqiang ZHOU, Shanghai (CN); Wei ZHANG, Lexington, MA (US); Lixia HU, Shanghai (CN); Zhuo ZHANG, Shanghai (CN); Jim Lewei JI, Shanghai (CN); Roy Shengli LING, Shanghai (CN); XiaoJun WU, Shanghai (CN); Jeff PURCELL, Holden, MA (US); Donald MACE, Mashpee, MA (US)

(73) Assignee: Dell Products L.P., Round Rock, TX (US)

(21) Appl. No.: 19/020,843

(22) Filed: Jan. 14, 2025

(51) Int. Cl. H04L 67/104

(52) U.S. Cl. CPC H04L 67/1051

(57) ABSTRACT

An information handling system may include at least one processor and a memory. The information handling system may be configured to: perform a first primary node election among a plurality of nodes of an information handling system cluster to determine a first primary node, wherein the first primary node election is based on a multi-cloud election algorithm; determine a cloud intent associated with the plurality of nodes; cause the first primary node to install a cloud-specific election component to the information handling system cluster; cause the cloud-specific election component to perform a second primary node election among the plurality of nodes to determine a second primary node, wherein the second primary node election is based on a cloud-specific election algorithm based on the determined cloud intent; and cause the second primary node to act as a primary node of the cluster of information handling systems.

### TECHNICAL FIELD

The present disclosure relates in general to information handling systems, and more particularly to the election of a primary node in a cluster of information handling systems.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Hyper-converged infrastructure (HCI) is an IT framework that combines storage, computing, and networking into a single system in an effort to reduce data center complexity and increase scalability. Hyper-converged platforms may include a hypervisor for virtualized computing, software-defined storage, and virtualized networking, and they typically run on standard, off-the-shelf servers. One type of HCI solution is the Dell EMC VxRail™ system. Some examples of HCI systems may operate in various environments (e.g., an HCI management system such as the VMware® vSphere® ESXi™ environment, or any other HCI management system). Some examples of HCI systems may operate as software-defined storage (SDS) cluster systems (e.g., an SDS cluster system such as the VMware® vSAN™ system, or any other SDS cluster system).

In the HCI context (as well as other contexts), information handling systems may execute virtual machines (VMs) for various purposes. A VM may generally comprise any program of executable instructions, or aggregation of programs of executable instructions, configured to execute a guest operating system on a hypervisor or host operating system in order to act through or in connection with the hypervisor/host operating system to manage and/or control the allocation and usage of hardware resources such as memory, central processing unit time, disk space, and input and output devices, and provide an interface between such hardware resources and application programs hosted by the guest operating system.

Some HCI systems use a cloud platform manager (e.g., APEX Cloud Platform™ from Dell®) for handling various cloud management tasks. For example, a cloud platform manager may be used to install a particular cloud OS onto a multi-cloud platform (MCP) HCI cluster and provision it for use with any one of a variety of cloud platforms (e.g., Amazon® AWS, Microsoft® Azure, Google® Cloud Platform, etc.). The choice of cloud platform for a cluster is referred to herein as the cluster's “cloud intent.”

In some cases, a cluster may elect one node as its primary node, which can act as the bootstrap node for setting up and provisioning the cluster. The primary node may be elected by powering on the nodes to be provisioned and allowing them to auto-discover each other over the network (e.g., by using mDNS or any other suitable technique for sharing information about themselves). Once the nodes have discovered one another, an election process may take place to select one node as primary.

For example, in one implementation, some designated characteristic of the nodes (e.g., their serial numbers) may be compared. The node with the lowest serial number may then be designated as the primary node. The primary node may present a wizard to the user to input information (e.g., the cloud intent and other information) for cluster provisioning, and it may then handle the rest of the provisioning process.

However, this type of election algorithm may not be suitable in situations where the cluster's cloud intent is unknown at the time of the election. This is because different cloud intents may have different requirements for the primary node's hardware configuration, and so simply selecting the node with the lowest serial number may not be guaranteed to satisfy these requirements.

For example, one cloud intent might require a storage node to serve as primary, while a different cloud intent might require a compute node to serve as primary. Another cloud intent might require that both a storage node and a compute node must be present in order to select a primary node. Yet other cloud intents might not impose any such requirements, instead allowing any node to serve as the primary. It is important to find a way to satisfy these and potentially other divergent requirements for primary nodes.

However, nodes may be initially delivered without any cloud intent selection. Further, even if the cloud intent is prepopulated into the node at the factory, the customer might choose a different cloud intent later when the nodes are delivered and powered on.

Accordingly, when the nodes are first powered on, it may be impossible to know which cloud stack they will be used for. The discovery and election algorithm for the primary node needs to be compatible with any cloud intent due to the differing requirements imposed by different cloud intents. Embodiments of this disclosure are thus directed to primary node election techniques that are usable even in the absence of cloud intent information.

It should be noted that the discussion of a technique in the Background section of this disclosure does not constitute an admission of prior-art status. No such admissions are made herein, unless clearly and unambiguously identified as such.

### SUMMARY

In accordance with the teachings of the present disclosure, the disadvantages and problems associated with primary node election may be reduced or eliminated.

In accordance with embodiments of the present disclosure, an information handling system may include at least one processor and a memory. The information handling system may be configured to: perform a first primary node election among a plurality of nodes of an information handling system cluster to determine a first primary node, wherein the first primary node election is based on a multi-cloud election algorithm; determine a cloud intent associated with the plurality of nodes; cause the first primary node to install a cloud-specific election component to the information handling system cluster; cause the cloud-specific election component to perform a second primary node election among the plurality of nodes to determine a second primary node, wherein the second primary node election is based on a cloud-specific election algorithm based on the determined cloud intent; and cause the second primary node to act as a primary node of the cluster of information handling systems.

In accordance with these and other embodiments of the present disclosure, a method may include an information handling system performing a first primary node election among a plurality of nodes of an information handling system cluster to determine a first primary node, wherein the first primary node election is based on a multi-cloud election algorithm; the information handling system determining a cloud intent associated with the plurality of nodes; the information handling system causing the first primary node to install a cloud-specific election component to the information handling system cluster; the information handling system causing the cloud-specific election component to perform a second primary node election among the plurality of nodes to determine a second primary node, wherein the second primary node election is based on a cloud-specific election algorithm based on the determined cloud intent; and the information handling system causing the second primary node to act as a primary node of the cluster of information handling systems.

In accordance with these and other embodiments of the present disclosure, an article of manufacture may include a non-transitory, computer-readable medium having computer-executable instructions thereon that are executable by an information handling system for: performing a first primary node election among a plurality of nodes of an information handling system cluster to determine a first primary node, wherein the first primary node election is based on a multi-cloud election algorithm; determining a cloud intent associated with the plurality of nodes; causing the first primary node to install a cloud-specific election component to the information handling system cluster; causing the cloud-specific election component to perform a second primary node election among the plurality of nodes to determine a second primary node, wherein the second primary node election is based on a cloud-specific election algorithm based on the determined cloud intent; and causing the second primary node to act as a primary node of the cluster of information handling systems.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with embodiments of the present disclosure;

FIG. 2 illustrates a block diagram of a multi-cloud discovery and election process, in accordance with embodiments of the present disclosure;

FIG. 3 illustrates a block diagram of preparation for a cloud-specific discovery and election process, in accordance with embodiments of the present disclosure; and

FIG. 4 illustrates a block diagram of a process for electing the cloud-specific primary node and installing cloud deployment tools, in accordance with embodiments of the present disclosure.

### DETAILED DESCRIPTION

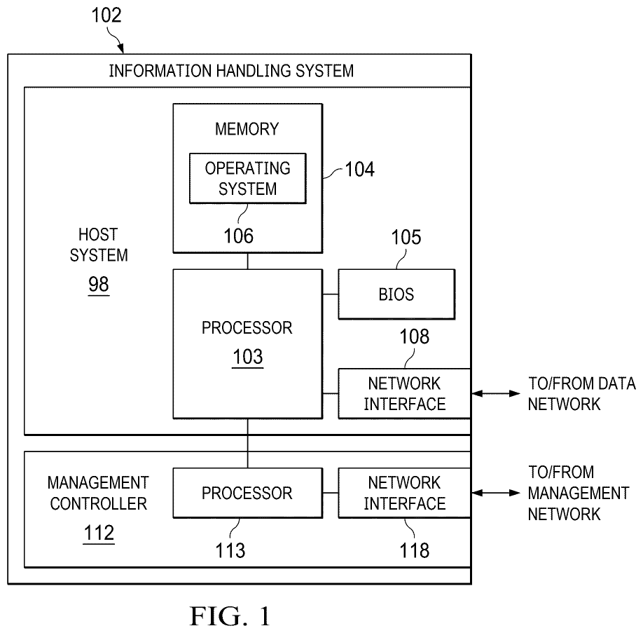

Preferred embodiments and their advantages are best understood by reference to FIGS. 1 through 4, wherein like numbers are used to indicate like and corresponding parts.

For the purposes of this disclosure, the term “information handling system” may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For purposes of this disclosure, when two or more elements are referred to as “coupled” to one another, such term indicates that such two or more elements are in electronic communication or mechanical communication, as applicable, whether connected directly or indirectly, with or without intervening elements.

When two or more elements are referred to as “coupleable” to one another, such term indicates that they are capable of being coupled together.

For the purposes of this disclosure, the term “computer-readable medium” (e.g., transitory or non-transitory computer-readable medium) may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; communications media such as wires, optical fibers, microwaves, radio waves, and other electromagnetic and/or optical carriers; and/or any combination of the foregoing.

For the purposes of this disclosure, the term “information handling resource” may broadly refer to any component system, device, or apparatus of an information handling system, including without limitation processors, service processors, basic input/output systems, buses, memories, I/O devices and/or interfaces, storage resources, network interfaces, motherboards, and/or any other components and/or elements of an information handling system.

For the purposes of this disclosure, the term “management controller” may broadly refer to an information handling system that provides management functionality (typically out-of-band management functionality) to one or more other information handling systems. In some embodiments, a management controller may be (or may be an integral part of) a service processor, a baseboard management controller (BMC), a chassis management controller (CMC), or a remote access controller (e.g., a Dell Remote Access Controller (DRAC) or Integrated Dell Remote Access Controller (iDRAC)).

FIG. 1 illustrates a block diagram of an example information handling system 102, in accordance with embodiments of the present disclosure. In some embodiments, information handling system 102 may comprise a server chassis configured to house a plurality of servers or “blades.” In other embodiments, information handling system 102 may comprise a personal computer (e.g., a desktop computer, laptop computer, mobile computer, and/or notebook computer). In yet other embodiments, information handling system 102 may comprise a storage enclosure configured to house a plurality of physical disk drives and/or other computer-readable media for storing data (which may generally be referred to as “physical storage resources”). As shown in FIG. 1, information handling system 102 may comprise a processor 103, a memory 104 communicatively coupled to processor 103, a BIOS 105 (e.g., a UEFI BIOS) communicatively coupled to processor 103, a network interface 108 communicatively coupled to processor 103, and a management controller 112 communicatively coupled to processor 103.

In operation, processor 103, memory 104, BIOS 105, and network interface 108 may comprise at least a portion of a host system 98 of information handling system 102. In addition to the elements explicitly shown and described, information handling system 102 may include one or more other information handling resources.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104 and/or another component of information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off.

As shown in FIG. 1, memory 104 may have stored thereon an operating system 106. Operating system 106 may comprise any program of executable instructions (or aggregation of programs of executable instructions) configured to manage and/or control the allocation and usage of hardware resources such as memory, processor time, disk space, and input and output devices, and provide an interface between such hardware resources and application programs hosted by operating system 106. In addition, operating system 106 may include all or a portion of a network stack for network communication via a network interface (e.g., network interface 108 for communication over a data network). Although operating system 106 is shown in FIG. 1 as stored in memory 104, in some embodiments operating system 106 may be stored in storage media accessible to processor 103, and active portions of operating system 106 may be transferred from such storage media to memory 104 for execution by processor 103.

Network interface 108 may comprise one or more suitable systems, apparatuses, or devices operable to serve as an interface between information handling system 102 and one or more other information handling systems via an in-band network. Network interface 108 may enable information handling system 102 to communicate using any suitable transmission protocol and/or standard. In these and other embodiments, network interface 108 may comprise a network interface card, or “NIC.” In these and other embodiments, network interface 108 may be enabled as a local area network (LAN)-on-motherboard (LOM) card.

Management controller 112 may be configured to provide management functionality for the management of information handling system 102. Such management may be made by management controller 112 even if information handling system 102 and/or host system 98 are powered off or powered to a standby state. Management controller 112 may include a processor 113, memory, and a network interface 118 separate from and physically isolated from network interface 108.

As shown in FIG. 1, processor 113 of management controller 112 may be communicatively coupled to processor 103. Such coupling may be via a Universal Serial Bus (USB), System Management Bus (SMBus), and/or one or more other communications channels.

Network interface 118 may be coupled to a management network, which may be separate from and physically isolated from the data network as shown. Network interface 118 of management controller 112 may comprise any suitable system, apparatus, or device operable to serve as an interface between management controller 112 and one or more other information handling systems via an out-of-band management network. Network interface 118 may enable management controller 112 to communicate using any suitable transmission protocol and/or standard. In these and other embodiments, network interface 118 may comprise a network interface card, or “NIC.” Network interface 118 may be the same type of device as network interface 108, or in other embodiments it may be a device of a different type.

As discussed above, embodiments of this disclosure may be used to elect a primary node in a cluster of information handling systems 102. At a high level, embodiments may rely on two different procedures: a multi-cloud platform (MCP) discovery and election procedure, and a cloud-specific discovery and election procedure.

For example, when the cloud intent of a cluster is unknown, the MCP process may be used to choose a default primary node.

When the cloud intent is known (e.g., having been populated at the factory or selected by the customer), the cloud-specific process may be used. For example, the cloud intent information may be populated to the nodes, they may be rebooted, and the cloud-specific procedure may commence.

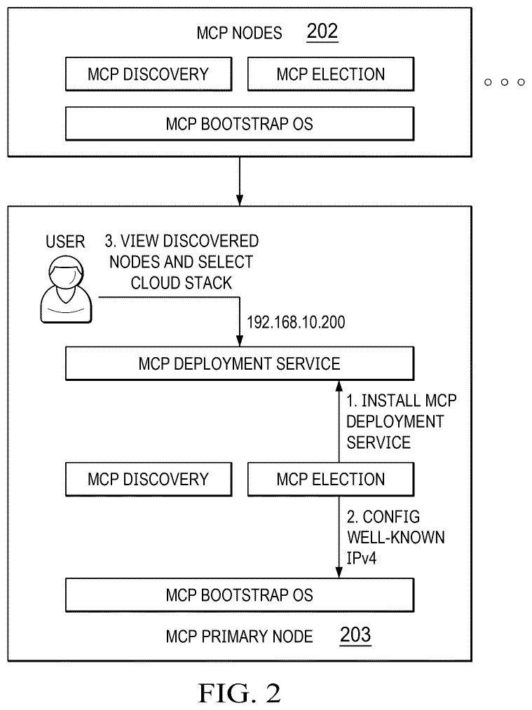

FIG. 2 illustrates an example of an MCP discovery and election process. Initially, when the nodes are powered on, they may all be in the state shown as MCP nodes 202. That is, they may all be configured as MCP generic nodes, running only an MCP bootstrap OS, an MCP discovery service, and an MCP election service.

Then a particular node may be selected as the MCP primary node 203. For example, the nodes may discover one another over the network, determining basic information such as the node serial numbers and MAC addresses. A predefined policy (e.g., specifying the lowest serial number) may be used to elect one of the MCP nodes 202 as the MCP primary node 203.

Once MCP primary node 203 has been elected, the MCP election service on that primary node may configure the node with a designated IP address that is known to the other nodes, and it may install an MCP deployment service. The MCP deployment service may then present a wizard to the user allowing selection of the cloud intent for the cluster.

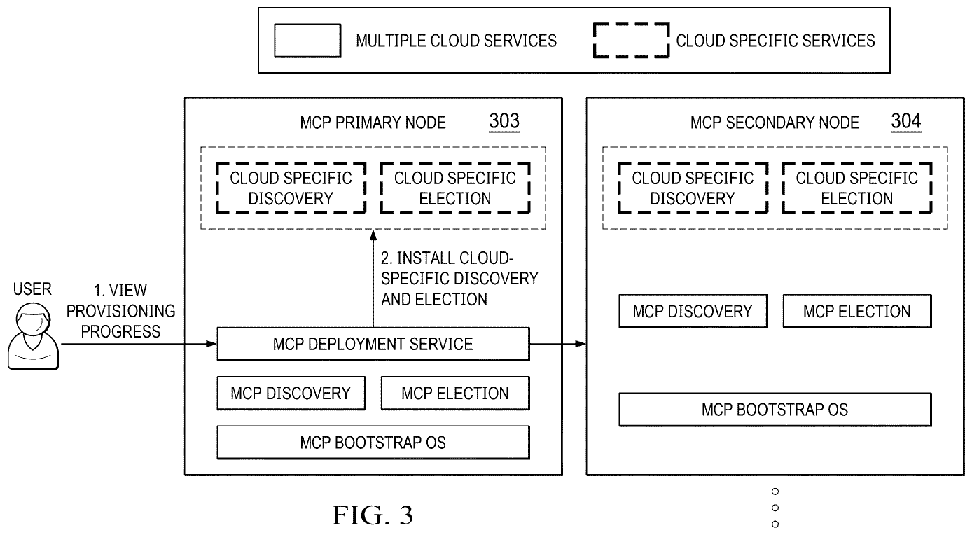

FIG. 3 illustrates an example of a process for setting the cluster up for cloud-specific discovery and election, after the procedure of FIG. 2 has been completed. MCP primary node 203 has been designated MCP primary node 303, and the other nodes have been designated MCP secondary nodes 304.

As shown, the MCP deployment service running on MCP primary node 303 may install the cloud-specific discovery and cloud-specific election components. These may be installed onto the MCP primary node 303, as well as onto all of the MCP secondary nodes 304.

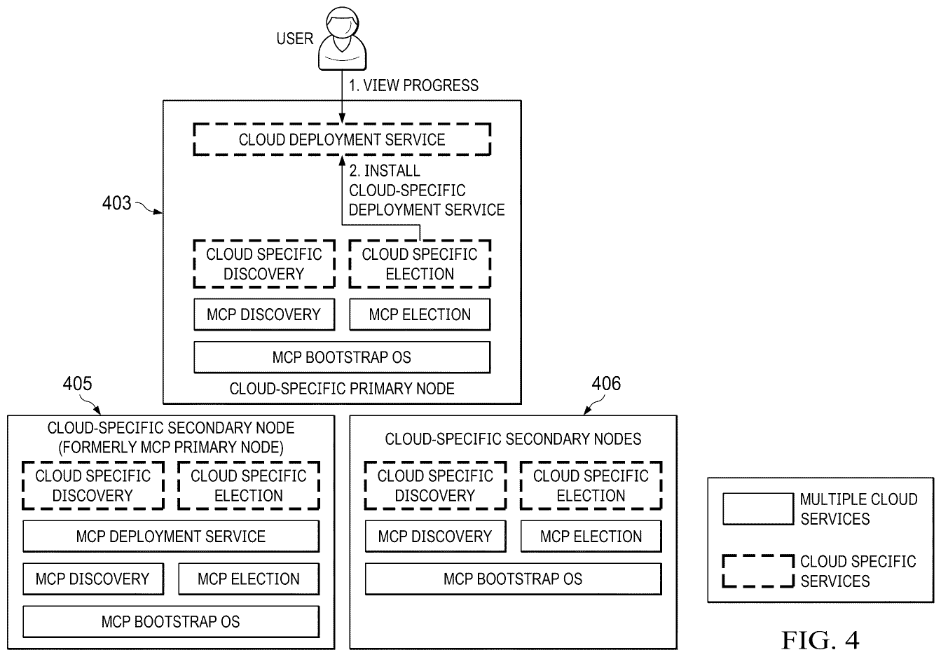

FIG. 4 illustrates an example of a process for electing the cloud-specific primary node and installing cloud deployment tools, after the procedure of FIG. 3 has been completed.

As discussed above, different cloud intents may have different primary-node requirements associated therewith. After the procedure of FIG. 3 has been completed, the cloud intent for the cluster is known, and the cloud-specific tools are in place to use that information. These tools may then perform cloud-specific discovery and cloud-specific election of a primary node that comports with any requirements that the designated cloud intent may impose.

For example, the cloud-specific election algorithm may be a modified version of the multi-cloud election algorithm. In one implementation, the cloud-specific election algorithm may be configured to select a lowest serial number among the nodes, but restricted to the subset of nodes that are appropriate as primary node candidates given the selected cloud intent.

This process culminates in the election of a new cloud-specific primary node 403. While it is possible that the cloud-specific primary node 403 may be selected as the same node as the prior MCP primary node, more commonly a different node may be elected as cloud-specific primary node 403.

Accordingly, FIG. 4 illustrates the former MCP primary node as a new cloud secondary node 405, while the remainder of the nodes are designated separately as other cloud secondary nodes 406. (As shown, the only difference may be that cloud secondary node 405 retains the MCP deployment service previously installed thereon.)

Once the cloud-specific primary node 403 has been elected, it may proceed to provision the cluster according to the target cloud intent. The cloud deployment service may provision the target cloud stack onto cloud-specific primary node 403 and cloud-specific secondary nodes 405 and 406. For example, it may install a cloud OS and any other tools associated with the target cloud intent. The cluster may then enter normal operation.

One of ordinary skill in the art with the benefit of this disclosure will understand that the preferred initialization points for the methods depicted in FIGS. 2-4 and the order of the steps comprising the methods may depend on the implementation chosen. In these and other embodiments, these methods may be implemented as hardware, firmware, software, applications, functions, libraries, or other instructions. Further, although FIGS. 2-4 disclose a particular number of steps to be taken with respect to the disclosed methods, the methods may be executed with greater or fewer steps than depicted. The methods may be implemented using any of the various components disclosed herein (such as the components of FIG. 1), and/or any other system operable to implement the methods.

This disclosure encompasses all changes, substitutions, variations, alterations, and modifications to the exemplary embodiments herein that a person having ordinary skill in the art would comprehend. Similarly, where appropriate, the appended claims encompass all changes, substitutions, variations, alterations, and modifications to the exemplary embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

Further, reciting in the appended claims that a structure is “configured to” or “operable to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke § 112(f) during prosecution, Applicant will recite claim elements using the “means for [performing a function]” construct.

All examples and conditional language recited herein are intended for pedagogical objects to aid the reader in understanding the invention and the concepts contributed by the inventor to furthering the art, and are construed as being without limitation to such specifically recited examples and conditions. Although embodiments of the present inventions have been described in detail, it should be understood that various changes, substitutions, and alterations could be made hereto without departing from the spirit and scope of the disclosure.

What is claimed is:

1. An information handling system comprising:
at least one processor; and
a memory;
wherein the information handling system is configured to:
perform a first primary node election among a plurality of nodes of an information handling system cluster to determine a first primary node, wherein the first primary node election is based on a multi-cloud election algorithm;
determine a cloud intent associated with the plurality of nodes;
cause the first primary node to install a cloud-specific election component to the information handling system cluster;
cause the cloud-specific election component to perform a second primary node election among the plurality of nodes to determine a second primary node, wherein the second primary node election is based on a cloud-specific election algorithm based on the determined cloud intent; and
cause the second primary node to act as a primary node of the cluster of information handling systems.

2. The information handling system of claim 1, wherein the multi-cloud election algorithm is based on serial numbers of the plurality of nodes.

3. The information handling system of claim 2, wherein the multi-cloud election algorithm comprises selecting a particular node based on its serial number being lower than all other node serial numbers of the information handling system cluster.

4. The information handling system of claim 1, wherein the cloud-specific election algorithm comprises a modified version of the multi-cloud election algorithm.

5. The information handling system of claim 4, wherein the cloud-specific election algorithm comprises selecting a particular node from a designated subset of the nodes of the information handling system cluster based on its serial number being lower than all other node serial numbers in the designated subset.

6. The information handling system of claim 1, wherein the second primary node is configured to carry out provisioning of the information handling system cluster.

7. A method comprising:
an information handling system performing a first primary node election among a plurality of nodes of an information handling system cluster to determine a first primary node, wherein the first primary node election is based on a multi-cloud election algorithm;
the information handling system determining a cloud intent associated with the plurality of nodes;
the information handling system causing the first primary node to install a cloud-specific election component to the information handling system cluster;
the information handling system causing the cloud-specific election component to perform a second primary node election among the plurality of nodes to determine a second primary node, wherein the second primary node election is based on a cloud-specific election algorithm based on the determined cloud intent; and
the information handling system causing the second primary node to act as a primary node of the cluster of information handling systems.

8. The method of claim 7, wherein the multi-cloud election algorithm is based on serial numbers of the plurality of nodes.

9. The method of claim 8, wherein the multi-cloud election algorithm comprises selecting a particular node based on its serial number being lower than all other node serial numbers of the information handling system cluster.

10. The method of claim 7, wherein the cloud-specific election algorithm comprises a modified version of the multi-cloud election algorithm.

11. The method of claim 10, wherein the cloud-specific election algorithm comprises selecting a particular node from a designated subset of the nodes of the information handling system cluster based on its serial number being lower than all other node serial numbers in the designated subset.

12. The method of claim 7, wherein the second primary node is configured to carry out provisioning of the information handling system cluster.

13. An article of manufacture comprising a non-transitory, computer-readable medium having computer-executable instructions thereon that are executable by an information handling system for:
performing a first primary node election among a plurality of nodes of an information handling system cluster to determine a first primary node, wherein the first primary node election is based on a multi-cloud election algorithm;
determining a cloud intent associated with the plurality of nodes;
causing the first primary node to install a cloud-specific election component to the information handling system cluster;
causing the cloud-specific election component to perform a second primary node election among the plurality of nodes to determine a second primary node, wherein the second primary node election is based on a cloud-specific election algorithm based on the determined cloud intent; and
causing the second primary node to act as a primary node of the cluster of information handling systems.

14. The article of manufacture of claim 13, wherein the multi-cloud election algorithm is based on serial numbers of the plurality of nodes.

15. The article of manufacture of claim 14, wherein the multi-cloud election algorithm comprises selecting a particular node based on its serial number being lower than all other node serial numbers of the information handling system cluster.

16. The article of manufacture of claim 13, wherein the cloud-specific election algorithm comprises a modified version of the multi-cloud election algorithm.

17. The article of manufacture of claim 16, wherein the cloud-specific election algorithm comprises selecting a particular node from a designated subset of the nodes of the information handling system cluster based on its serial number being lower than all other node serial numbers in the designated subset.

18. The article of manufacture of claim 13, wherein the second primary node is configured to carry out provisioning of the information handling system cluster.
